(19) United States
(12) Patent Application Publication
(10) Pub. No.: US 2026/0138109 A1
(43) Pub. Date: May 21, 2026

(54) Methods for Modifying a Supported Catalyst During Olefin Polymerization

(71) Applicant: ExxonMobil Technology and Engineering Company, Spring, TX (US)

(72) Inventors: Garret L. Broussard, Baton Rouge, LA (US); Brent A. Garrison, Port Neches, TX (US); Lanston G. Monceaux, Orange, TX (US); Xuan Ye, Houston, TX (US); Adriana S. Silva, Houston, TX (US); Kevin A. Stevens, Somerville, NJ (US); Ryan W. Impelman, Houston, TX (US); Michael D. Lucas, Houston, TX (US); Christian T. Lund, Beaumont, TX (US); Richard E. Pequeno, Baytown, TX (US); Jason R. Fischer, Houston, TX (US); Sebastian Chialvo, Spring, TX (US)

(21) Appl. No.: 19/148,860

(22) PCT Filed: Mar. 6, 2024
(86) PCT No.: PCT/US2024/018706

§ 371 Date: Jul. 17, 2025

Related U.S. Application Data
(60) Provisional application No. 63/489,948, filed on Mar. 13, 2023.

(51) Int. Cl. B01J 8/18; B01J 8/22; C08F 210/02

(52) U.S. Cl. CPC B01J 8/1872; B01J 8/22; C08F 210/02; B01J 2208/00752

(57) ABSTRACT

Polymer sheeting may be decreased by increasing the contact time between a catalyst solution and a catalyst slurry. Polymerization methods may comprise: introducing a catalyst slurry to a line in fluid communication with a mixing unit; introducing at least a first portion of a catalyst solution to the line upstream from the mixing unit; contacting the catalyst slurry with the catalyst solution in the line and in the mixing unit to obtain a modified catalyst slurry from the mixing unit, the modified catalyst slurry comprising a modified supported catalyst incorporating at least a portion of a first catalyst compound or a second catalyst compound from the catalyst solution; feeding the modified catalyst slurry to a fluidized bed gas-phase reactor; and polymerizing an α-olefin in the fluidized bed gas-phase reactor under polymerization conditions to obtain a polyolefin.

### CROSS-REFERENCE TO RELATED APPLICATIONS

This application claims the benefit of U.S. Provisional Application 63/489,948, filed Mar. 13, 2023, entitled “Methods for Modifying a Supported Catalyst During Olefin Polymerization”, the entirety of which is incorporated by reference herein.

### FIELD

The present disclosure relates to methods for polymerizing one or more olefins, and more particularly, methods for polymerizing one or more olefins utilizing enhanced supported catalyst mixing techniques prior to polymerization.

### BACKGROUND

Gas-phase polymerization is useful for polymerizing ethylene or ethylene and one or more olefin co-monomers. Gas-phase polymerization processes conducted in fluidized beds are particularly economical. One or more olefin monomers and catalyst particles containing an activated catalyst compound can be introduced into a polymerization reactor, in which the olefin monomer(s) can polymerize in the presence of the catalyst particles to produce a polyolefin product, preferably in fine particle form.

During polymerization, the catalyst particles (i.e., a supported catalyst) can begin to overheat, especially when a catalyst compound upon the catalyst particles has an aggressive kinetic profile. When the catalyst particles overheat, the polymer particles within the reactor can begin to stick together, which can lead to the eventual buildup of polymer within the reactor. The buildup of polymer within the reactor, which is usually referred to as agglomeration, chunking, or sheeting, can lead to process upsets and even reactor shutdown in some cases. The term sheeting is used herein.

One way in which overheating of the catalyst particles can be tempered is by changing the ratio of catalyst compound(s) upon the catalyst particles. For maximum process flexibility, modification of the catalyst particles may take place in situ prior to delivery to a polymerization reaction without process shutdown taking place. In some examples, a catalyst solution may be contacted with the catalyst particles to introduce additional catalyst compound onto the catalyst particles and/or to introduce a different catalyst compound onto the catalyst particles. The catalyst solution introducing the additional catalyst compound and/or the different catalyst compound to the catalyst particles may be referred to as a “trim catalyst” or “trim catalyst solution,” since the catalyst solution modulates the performance of the original catalyst particles. Unfortunately, modification of catalyst particles in situ in the foregoing manner may lead to sub-optimal catalyst activation and continued challenges with process control, including sheeting of the resulting polymer. Short and/or variable contact times between the catalyst particles and the trim catalyst solution may be especially problematic, since multiple supported catalysts having varied polymerization properties may be produced.

Some references of potential interest in this area include U.S. Pat. No. 10,927,205, US Pat. Pub. Nos. US2022/0033536 and US2022/0033537; and International Pat. Pub. No. WO2022/174202.

Thus, there remains a need for improved processes for polymerizing one or more olefin monomers during gas-phase polymerization to reduce or eliminate polymer buildup within the reactor.

### SUMMARY

In various aspects, methods of the present disclosure comprise: providing a catalyst slurry comprising a supported catalyst, the supported catalyst comprising a support material, at least one catalyst compound, and at least one activator; introducing the catalyst slurry to a line in fluid communication with a mixing unit; introducing at least a first portion of a catalyst solution to the line upstream from the mixing unit, the catalyst solution comprising a first catalyst compound already contained upon the supported catalyst or a second catalyst compound different from the first catalyst compound and not already contained upon the supported catalyst; contacting the catalyst slurry with the catalyst solution in the line and in the mixing unit to obtain a modified catalyst slurry from the mixing unit, the modified catalyst slurry comprising a modified supported catalyst incorporating at least a portion of the first catalyst compound or the second catalyst compound from the catalyst solution; feeding the modified catalyst slurry to a fluidized bed gas-phase reactor; and polymerizing an α-olefin in the fluidized bed gas-phase reactor under polymerization conditions to obtain a polyolefin.

These and other features and attributes of the disclosed methods of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a block diagram schematic of a gas-phase reactor system, in which mixing of a catalyst slurry and a catalyst solution may take place in a mechanically agitated mixing pot.

FIG. 2 is a block diagram schematic of a gas-phase reactor system, in which mixing of a catalyst slurry and a catalyst solution may take place inline upstream from a static mixer or mixing block.

FIG. 3 is a block diagram schematic of a gas-phase reactor system, in which mixing of a catalyst slurry and a catalyst solution may take place inline upstream from a mechanically agitated mixing pot.

FIG. 4 is a graph of H₂/ethylene flow ratio and extent of polymer sheeting under conventional catalyst slurry/catalyst solution contacting conditions and extended catalyst slurry/catalyst solution contacting conditions according to the disclosure herein.

### DETAILED DESCRIPTION

The present disclosure relates to methods for polymerizing one or more olefins, and more particularly, methods for polymerizing one or more olefins utilizing enhanced supported catalyst mixing techniques prior to polymerization.

As discussed above, catalyst particles (i.e., a supported catalyst) may be modified in situ prior to conducting a polymerization reaction, such as to mitigate polymer sheeting. However, in situ modification of catalyst particles may lead to ineffective catalyst activation and continued difficulties with a polymerization process. The foregoing difficulties may be addressed through the disclosure herein. In particular, the present disclosure provides increased and/or less variable contact times between catalyst particles and a catalyst solution when producing a modified supported catalyst. More consistent polymerization performance may be realized as a result.

### Definitions

Various specific embodiments, versions and examples of the invention will now be described, including preferred embodiments and definitions that are adopted herein for purposes of understanding the claimed invention. While the following detailed description gives specific preferred embodiments, those skilled in the art will appreciate that these embodiments are exemplary only, and that the invention may be practiced in other ways. For purposes of determining infringement, the scope of the invention will refer to any one or more of the appended claims, including their equivalents, and elements or limitations that are equivalent to those that are recited. Any reference to the “invention” may refer to one or more, but not necessarily all, of the inventions defined by the claims.

As used herein, the indefinite article “a” or “an” shall mean “at least one” unless specified to the contrary or the context clearly indicates otherwise. Thus, embodiments using “an alpha-olefin” include embodiments where one, two, or more alpha-olefins are used, unless specified to the contrary or the context clearly indicates that only one alpha-olefin is used.

Unless otherwise indicated, all numbers indicating quantities in this disclosure are to be understood as being modified by the term “about” in all instances. It should also be understood that the precise numerical values used in the specification and claims constitute specific embodiments.

The term “and/or” as used in a phrase such as “A and/or B” herein is intended to include “A and B,” “A or B,” “A,” and “B.”

As used herein, “wt %” means percentage by weight, “vol %” means percentage by volume, “mol %” means percentage by mole, “ppm” means parts per million, and “ppm wt” and “wppm” are used interchangeably and mean parts per million on a weight basis. All concentrations herein, unless otherwise stated, are expressed on the basis of the total amount of the composition in question.

For the purposes of this disclosure, the nomenclature of elements is pursuant to the NEW NOTATION version of the Periodic Table of Elements as provided in Hawley's Condensed Chemical Dictionary, 16^{th} Ed., John Wiley & Sons, Inc., (2016), Appendix V unless otherwise noted.

As used herein, the terms “optional” or “optionally” mean that the subsequently described event or circumstance does or does not occur (or an element is or is not present) and that the description includes instances where said event or circumstance occurs and instances where said event or circumstance does not occur.

A “reactor” is any type of vessel or containment device in any configuration of one or more reactors, and/or one or more reaction zones, wherein a similar polymer is produced. The term “gas-phase polymerization” refers to the production of polymer in a gas-phase reactor (referred to herein simply as a “reactor”). It should also be noted that when a “gas-phase” polymerization or reactor is referenced, it is contemplated that monomers are typically reacted in a gas phase in a reaction zone; however, the monomers need not necessarily be supplied to the reactor in a gas phase. Rather, the monomers may be supplied in a gas phase, liquid phase (condensed phase), or a hybrid gas-liquid phase. Accordingly, when gaseous monomeric streams or cycle gas streams are referenced herein as part of a gas-phase polymerization reactor system or process, it should be understood that such gas streams can in fact be at least partially condensed (that is, in a gas-liquid hybrid phase). In other words, any stream referenced as a gas stream, recirculated gas, or the like, in the context of a gas-phase reaction system as described herein, can be considered to optionally be at least partially liquefied, as is known in the art. See discussion of so-called “condensed mode” of operating certain gas-phase polymerization reactors, e.g., in Namkajorn et al., Condensed Mode Cooling for Ethylene Polymerization: Part III. The Impact of Induced Condensing Agents on Particle Morphology and Polymer Properties, J. MACROMOL. CHEM. AND PHYS. 217, 1521-1528 (Wiley 2016), where it is noted that in some fluidized bed gas-phase polymerization reactors, recycle stream or cycle gas can be cooled to a temperature below its dew point so that it is partially liquified, and then fed into the bottom of the fluidized bed reactor, where latent heat of vaporization of the liquid in the feed absorbs the heat of polymerization and thereby offers increased cooling and the potential for increased reaction rates.

“Alkoxides” include an oxygen atom bonded to an alkyl group that is a C₁ to C₁₀ hydrocarbyl. The alkyl group may be straight chain, branched, or cyclic. The alkyl group may be saturated or unsaturated. In at least one embodiment, the alkyl group may comprise at least one aromatic group.

The terms “anti-static agent,” “continuity additive,” “continuity aid,” and “antifoulant agent” are interchangeable and refer to compounds or mixtures of compounds, such as solids and/or liquids that are useful during polymerization to reduce fouling of a reactor. Fouling of the reactor may be caused by polymer buildup within the reactor. Fouling of the reactor can be manifested by any number of phenomena including sheeting of the reactor walls, plugging of inlet and outlet lines, formation of large agglomerates, or other forms of polymer build up within the reactor that can lead to a shutdown of the reactor. The anti-static agent can be used as a part of a catalyst composition or introduced directly into the reactor independent of the catalyst composition. In some embodiments, the anti-static agent can be included on a support that also supports one or more catalysts.

The term “catalyst” can be used interchangeably with the terms “catalyst compound,” “catalyst precursor,” “transition metal compound,” “transition metal complex,” and “pre-catalyst.”

A “catalyst system” is a combination of one or more catalyst compounds, an activator, an optional co-activator, and an optional support material. For the purposes of the present disclosure, when catalyst systems are described as comprising neutral stable forms of the components, it is well understood by one of ordinary skill in the art, that the ionic form of the component is the form that reacts with the monomers to produce polymers. Catalyst systems, catalysts, and activators of the present disclosure are intended to embrace ionic forms in addition to the neutral forms of the compounds/components.

The terms “group,” “radical,” and “substituent” may be used interchangeably herein.

The term “hydrocarbon” refers to a class of compounds having hydrogen bound to carbon, and encompasses saturated hydrocarbon compounds, unsaturated hydrocarbon compounds, and mixtures of hydrocarbon compounds (saturated and/or unsaturated), including mixtures of hydrocarbon compounds having different numbers of carbon atoms. The term “C” refers to hydrocarbon(s) or a hydrocarbyl group having n carbon atom(s) per molecule or group, wherein n is a positive integer. Such hydrocarbon compounds may be one or more of linear, branched, cyclic, acyclic, saturated, unsaturated, aliphatic, or aromatic.

The terms “hydrocarbyl radical,” “hydrocarbyl group,” or “hydrocarbyl” may be used interchangeably and are defined to mean a group consisting of hydrogen and carbon atoms only and bearing at least one unfilled valence position when removed from a parent compound.

The term “optionally substituted” means that a hydrocarbon or hydrocarbyl group can be unsubstituted or substituted. Unless otherwise specified as being expressly unsubstituted, any of the hydrocarbyl groups herein may be optionally substituted. The term “substituted” means that at least one hydrogen atom in a parent hydrocarbyl group has been replaced with at least a non-hydrogen group, such as a hydrocarbyl group, a heteroatom, or a heteroatom-containing group.

An “olefin” is a linear, branched, or cyclic compound of carbon and hydrogen having at least one double bond. When a polymer or copolymer is referred to as including an olefin, e.g., ethylene and/or at least one C₃ to C₂₀ α-olefin, the olefin present in such polymer or copolymer is the polymerized form of the olefin. For example, when a copolymer is said to have an “ethylene” content of about 35 wt % to about 55 wt %, it is understood that the repeating unit/mer unit or simply unit in the copolymer is derived from ethylene in the polymerization reaction and the derived units are present at about 35 wt % to about 55 wt %, based on a weight of the copolymer. For the purposes of the present disclosure, ethylene shall be considered an α-olefin.

A “polymer” has two or more of the same or different repeating units/mer units or simply units (monomer units). A “homopolymer” is a polymer having units that are the same. A “copolymer” is a polymer having two or more units that are different from each other. A “terpolymer” is a polymer having three units that are different from each other. The term “different” as used to refer to units indicates that the units differ from each other by at least one atom or are different isomerically. The definition of copolymer, as used herein, includes terpolymers and the like. Likewise, the definition of polymer, as used herein, includes homopolymers, copolymers, and the like. Furthermore, the terms “polyethylene copolymer”, “ethylene copolymer”, and “ethylene-based polymer” are used interchangeably to refer to a copolymer that includes at least 50 mol % of units derived from ethylene.

The term “characteristic mass transfer time” refers to the time scale over which diffusion occurs. Once multiple (e.g., 2, 3, 4, 5, or even greater) characteristic mass transfer times have passed, diffusion-based mixing may be considered complete. The methods of the present disclosure may extend the contact time between a catalyst solution and a catalyst slurry beyond the characteristic mass transfer time over which interparticle diffusion occurs. By extending the contact time beyond the characteristic mass transfer time, additional time becomes available for a second catalyst to diffuse into a supported catalyst (intraparticle diffusion) and for catalyst activation to occur. The time over which mass transfer occurs may be shortened beyond that realized with diffusion only, such as through use of a mechanically agitated mixing pot.

### Polymerization Processes and Activation of Catalyst Compounds

When utilizing a supported catalyst containing one or more catalyst compounds, it may become necessary to modify the final supported catalyst, such as to alter the kinetic profile during polymerization or change the composition or characteristics of the polymer being produced, by introducing additional catalyst compound(s) onto the supported catalyst. The additional catalyst compound(s) being introduced may increase the loading of a catalyst compound already present upon the supported catalyst and/or introduce a different catalyst compound not already present upon the supported catalyst. One way in which modification of the supported catalyst may be performed is through contacting (i) the supported catalyst within a catalyst slurry with (ii) a catalyst solution containing one or more of the catalyst compounds, thereby producing a modified supported catalyst within a modified catalyst slurry. The modified catalyst slurry may have a different loading of at least one catalyst compound upon the support material, as compared to the original (pre-contact) catalyst slurry. When producing a modified catalyst slurry in situ in the foregoing manner, the kinetic profile and/or contact time of the modified catalyst slurry are desirably controlled with a specified degree of precision. Otherwise, inadequate kinetic control may, for example, lead to thermal swing and pressure differentials to result in rheological changes in the catalyst slurry and/or the catalyst solution that may lead to interference within the catalyst system and potentially produce polymer sheeting. Inadequate activation may also occur for the catalyst compound(s) being newly introduced, thus failing to alter the catalyst performance to a sufficient degree during a polymerization reaction. An overly aggressive kinetic profile, for example, may lead to polymer sheeting within the reactor if the kinetic profile is not altered to a sufficient degree. Alternately or additionally, if the supported catalyst is not modified to a sufficient degree, an off-specification polymer may be produced during the gas-phase polymerization reaction. When introducing modified supported catalyst produced from multiple sources and/or formed in situ within different lines, inconsistent modification and activation may prove very problematic, since the wrong polymer product may be produced or sheeting may become more prevalent. Inconsistent and/or short contact times between catalyst particles and a trim catalyst solution may lead to these issues and others.

Without being bound by theory or mechanism, it is believed that a catalyst compound being introduced to a supported catalyst from a catalyst solution may experience sub-optimal activation as a consequence of limited diffusion into the interior of the support material to enable the catalyst compound to contact a co-supported activator in the interior of the support material. By increasing the contact time between a catalyst slurry containing the supported catalyst and the catalyst solution prior to the modified catalyst slurry resulting therefrom entering a polymerization reactor, activation of the catalyst compound introduced from the catalyst solution may be enhanced Highly variable contact times may also be problematic, as the original catalyst particles may undergo more or less modification than desired, potentially leading to formation of an undesired polymer product (e.g., by continuously feeding supported catalyst having unintentionally differing amounts of activated catalyst compound thereon, varying with time due to such inconsistent contact times). Surprisingly, the enhanced catalyst activation resulting from an increased contact time between the catalyst solution and the catalyst slurry according to the disclosure herein may afford improved performance during gas-phase polymerization reactions employing the supported catalysts following modification thereof. At the very least, the enhanced catalyst activation may decrease sheeting within the gas-phase polymerization reactor. Various approaches for increasing the contact time between the catalyst slurry and the catalyst solution to afford improved polymerization performance are described in further detail herein. The increased contact time between the catalyst slurry may be at least beyond the characteristic mass transfer mixing time, according to more specific examples.

Although the present disclosure provides for enhanced slurry catalyst activation through more effective contacting of a supported catalyst and a catalyst solution, it is to be appreciated that consistent delivery of the modified supported catalyst to a reactor is also a factor in achieving good polymerization performance. For example, when introducing modified supported catalyst through multiple lines, keeping the delivery rate consistent between lines can maintain improved polymerization performance. Providing a consistent delivery rate of modified supported catalyst through multiple lines may involve heating or cooling the lines individually to control the viscosity and delivery rate, or using pinch valve so slow the delivery rate in individual lines on an as-needed basis.

In order for the embodiments of the present disclosure to be better understood, reference is now made to the drawings showing polymerization processes and reactor systems in which a modified catalyst slurry may be produced and fed to a gas-phase polymerization reactor. It is to be appreciated by one having ordinary skill in the art that elements such as pumps, heat exchangers, valves, and similar system components may be present in the depicted processes and reactor systems, but such elements have been omitted in the interest of clarity. Moreover, elements having a similar structure and function in multiple figures will utilize in-common reference characters herein, and such elements will only be described in detail at their first occurrence in the interest of brevity.

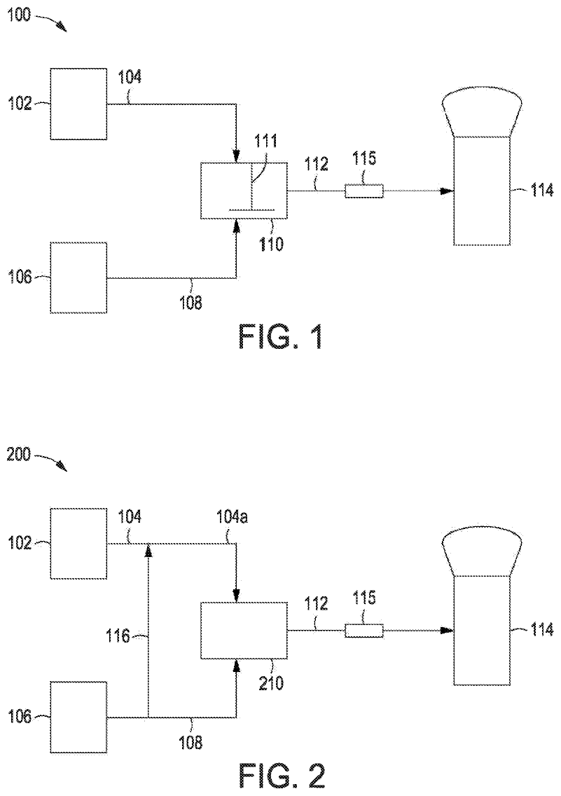

FIG. 1 is a block diagram schematic of gas-phase reactor system 100, in which mixing of a catalyst slurry and a catalyst solution may take place using a mechanically agitated mixing pot. As shown, first catalyst-containing mixture containing a supported catalyst in a suitable carrier liquid can be introduced into first vessel 102. The first vessel 102 optionally can be an agitated holding vessel configured to keep the solids concentration of the supported catalyst substantially constant in the catalyst slurry. As a further option, the vessel 102 can be maintained at an elevated temperature, such as from 30° C., 40° C., or 43° C. to 45° C., 60° C., or 75° C. Elevated temperature can be obtained by electrically heating the holding vessel with, for example, a heating blanket. Maintaining the holding vessel at an elevated temperature can further reduce or eliminate solid residue formation on vessel walls which could otherwise slide off the walls and cause plugging in downstream delivery lines. In at least one embodiment, the holding vessel can have a volume of 0.75 m³, 1.15 m³, 1.5 m³, 1.9 m³, or 2.3 m³ to 3 m³, 3.8 m³, 5.7 m³, or 7.6 m³. It is to be appreciated that the volume of the holding vessel may be selected in response to the rate of catalyst consumption. In non-limiting examples, the volume of the holding vessel may be selected to afford a run time of at least about 12 hours, such as about 12 hours to about 96 hours, or about 12 hours to about 72 hours, or about 12 hours to about 48 hours, or about 12 hours to about 24 hours, or about 24 hours to about 72 hours, or about 48 hours to about 96 hours.

The supported catalyst may comprise a support material, at least one activator, and at least one catalyst compound. The at least one catalyst compound may comprise at least a first catalyst compound and optionally a second catalyst compound, wherein the first catalyst compound and the second catalyst compound are different from one another. The first catalyst-containing mixture may comprise a catalyst slurry.

A second catalyst-containing mixture containing the first catalyst compound or the second catalyst compound may be introduced to second vessel 106. The second catalyst-containing mixture may comprise a catalyst solution. The second vessel 106 optionally can be a tank having a sufficient volume to suitably modify the supported catalyst according to the description herein. The tank for the catalyst solution can have a volume of 0.38 m³, 0.75 m³, 1.15 m³, 1.5 in, 1.9 m³, or 2.3 m³ to 3 m³, 3.8 m³, 5.7 m³, or 7.6 m³. It is to be appreciated that the volume of the tank may be selected in response to the rate of catalyst consumption. In non-limiting examples, the volume of the tank may be selected to afford a run time of at least about 12 hours, such as about 12 hours to about 96 hours, or about 12 hours to about 72 hours, or about 12 hours to about 48 hours, or about 12 hours to about 24 hours, or about 24 hours to about 72 hours, or about 48 hours to about 96 hours. The tank for the catalyst solution can be maintained at an elevated temperature, such as from 30° C., 40° C., or 43° C. to 45° C., 60° C., or 75° C., which may be obtained by electrically heating the tank with, for example, a heating blanket. Maintaining the tank at an elevated temperature can provide reduced or eliminated foaming when combining the catalyst slurry with the catalyst solution according to the description herein.

In conventional reactor systems producing a modified supported catalyst, the catalyst slurry is conveyed through line 104 and the catalyst solution is conveyed through line 108 to a static mixer or mixing block, which may afford a total contact time of about 1-2 minutes between the catalyst solution and the catalyst slurry as the resulting modified catalyst is being conveyed through line 112 to reactor 114. Contact times within the static mixer or mixing block itself may only be in the range of only a few seconds.

In one process configuration of the present disclosure, shown in FIG. 1, the contact time between the catalyst solution and the catalyst slurry may be increased by supplementing or replacing the static mixer or mixing block of an incumbent system with a mechanically agitated mixing pot, such as mixing pot 110. A mechanically agitated mixing pot may provide more thorough (higher quality) and longer mixing than is feasible with a static mixer or mixing block, as discussed subsequently. Catalyst slurry is conveyed from the first vessel 102 through line 104 and catalyst solution is conveyed from second vessel 106 through line 108 directly to mechanically agitated mixing pot 110, which may include one or more impellers 111 to promote agitation therein. For example, the one or more impellers 111 may be present in a mixing pot 110 defining a pitched blade turbine. In addition to the volume and configuration of mechanically agitated mixing pot 110, the rotation rate of the one or more impellers 111 may impact the residence time of the catalyst slurry in mixing pot 110. Mechanically agitated mixing pot 110 may feature a volume and configuration sufficient to afford a contact time that is at least about 5 minutes greater than that produced by a mixing block or static mixer alone. In non-limiting examples, mechanically agitated mixing pot 110 may afford a contact time within the mixing pot 110 between the catalyst slurry and the catalyst solution of about 20, 22, 25, 27, 28, or 30 minutes to about 30, 33, 35, 37, 38, 39, 40, 42, 45, or 50 minutes (with ranges from any foregoing low end to any foregoing high end contemplated, such as 30 to 40 minutes). In addition to the increased contact time, mechanically agitated mixing pot 110 may improve the quality of mixing beyond just diffusion-limited processes. Without being bound by theory or mechanism, the mechanical agitation may provide greater homogenization of the catalyst solution throughout the catalyst slurry and reduce the thickness of a mass transfer boundary layer upon the catalyst particles, thereby allowing faster mass transfer of the catalyst from the catalyst solution into the catalyst particles for activation to occur.

The mechanically agitated mixing pot may, for example, have a total volume of about 10 L to about 30 L, or about 10 L to about 20 L, or about 15 L to about 25 L, or about 20 L to about 30 L. Volumes in the foregoing ranges, coupled with the design configuration of the mechanically agitated mixing pot, may be sufficient to afford contact times of about 30-40 minutes in the mechanically agitated mixing pot. It is to be appreciated that the volume may be adjusted up or down from these foregoing ranges, depending on catalyst feed rates, to maintain contact times within a desired specified range. Variance in the catalyst productivity (kg of catalyst per kg of polymer) and/or variance in production rates (kg/hr of polymer production) may further prompt an increase or decrease in volume of the mechanically agitated mixing pot to accomplish a desired contact time and/or quality of mixing.

In addition to the volume, other mechanically agitated mixing pots suitable for use in the disclosure herein include, but are not limited to any of the types of agitated mixing vessels described in the Handbook of Industrial Mixing (2004, Editors: Paul, Atiemo-Obeng, and Kresta). The vessel defining the mechanically agitated mixing pot may comprise any suitable shape such as, primarily cylindrical with multiple types of vessel heads and bottoms (such as flat, ellipsoidal, or conical). Baffles may be optionally used depending on impeller selection to prevent solid body rotation and to enhance axial mixing. In some embodiments, the vessel may be staged with a horizontal baffle to provide multiple connected chambers. In any embodiment, the vessel may be vertical, horizontal, or inclined. In any embodiment, the impeller(s) may be installed from the top, bottom, or side of the vessel, axial or tilted, centered or off centered, or any combination thereof. Each impeller (e.g., one, two, three, four, or even more impellers of the same or different types) may be any of axial flow, radial flow, mixed flow, close contact, helical ribbon, or any combination thereof. The impeller(s) may be sized to different ratios of vessel diameter, located at varying heights from vessel bottom, and can be of different types to affect different mixing regimes in different sections of the vessel. The inlet and effluent locations can be located in different locations of the vessel according to desired mixing performance. A liquid level within the vessel may be manipulated to be partially full to completely liquid full (i.e., no or limited vapor space).

In one non-limiting example, the vessel may be a cylindrical vessel with a conical bottom with a 15 degree taper, and baffled with an axial impeller shaft equipped with two pitched turbine blade impellers. The catalyst slurry and the catalyst solution may be charged into the top of the vessel filled with liquid, and effluent may be drawn from the bottom, where a direct line from the inlet to the exit passes through the space of the impellers.

As the catalyst slurry and catalyst solution are contacted in the mixing pot 110, a modified catalyst slurry comprising a modified supported catalyst is obtained and then conveyed to reactor 114 via line 112. Optionally, one or more static mixers 115 may reside within line 112, which may provide additional contact time for mixing, if needed. Although line 112 has been depicted as a single line in FIG. 1, it is to be appreciated that line 112 may alternately comprise a plurality of lines to deliver the modified catalyst slurry to reactor 114 at multiple locations and/or at different flow rates (e.g., the lines may be in configuration for parallel flow of the modified catalyst slurry through the lines). For example, line 112 may comprise one, two, three, four, five, six or more lines in parallel, each operating independently of one another and having independent thermal control with respect to each other. Moreover, other components may be delivered to reactor 114 via line 112 (or multiple lines 112), either being combined with the modified catalyst slurry in one or more lines and/or introduced in one or more separate lines not containing the modified catalyst slurry. Such other components are discussed in more detail below.

It should be understood that while a modified catalyst slurry that includes at least two catalyst compounds is described herein, the modified catalyst slurry may comprise a single catalyst compound if suitable for a particular process (e.g., where the supported catalyst comprises the catalyst compound deposited thereon; and the catalyst solution comprises the same catalyst compound, such that control of the amount of catalyst solution mixed with catalyst slurry de facto controls amount of deposited catalyst compound). Likewise, the modified catalyst slurry could comprise three or more catalyst compounds, depending on particular process requirements (e.g., one, two or three compounds could be present on the supported catalyst in the slurry; and one or two catalyst compounds added by the solution to provide on-the-fly control of the ratio of the compounds; and so on for different numbers of different catalyst compounds).

Reactor 114 can include a reaction zone and a velocity reduction zone. The reaction zone can include a bed that can include growing polymer particles, formed polymer particles and a minor amount of catalyst particles fluidized by the continuous flow of the gaseous monomer and diluent to remove the heat of polymerization through the reaction zone. An olefinic feed gas may be provided to reactor 114 and recirculated therethrough. Optionally, some of the re-circulated gases can be cooled and compressed to form liquids (e.g., where the gases include induced condensing agents (ICAs)), that can increase the heat removal capacity of the circulating gas stream when readmitted to the reaction zone. Make-up of gaseous monomer to the circulating gas stream can be at a rate equal to the rate at which particulate polymer product and monomer associated therewith is withdrawn from the reactor, and the composition of the gas passing through the reactor can be adjusted to maintain an essentially steady state gaseous composition within the reaction zone. The gas leaving the reaction zone can be passed to the velocity reduction zone where entrained particles can be removed, for example, by slowing and falling back to the reaction zone below the velocity reduction zone. If desired, finer entrained particles and dust can be removed in a separation system, such as a cyclone and/or fines filter. The recirculating gas can be passed through a heat exchanger where at least a portion of the heat of polymerization can be removed and/or the recirculating gas can be compressed and returned to the reaction zone.

In another suitable process configuration of the present disclosure, the contact time between the catalyst solution and the catalyst slurry may be increased by contacting the catalyst slurry and the catalyst solution in a line prior to further mixing in a mixing location, such as a static mixer or mixing block. In this case, a static mixer or mixing block may continue to be suitably used as the mixing location as a consequence of the increased mixing times produced upstream therefrom. FIG. 2 is a block diagram schematic of gas-phase reactor system 200, in which mixing of a catalyst slurry and a catalyst solution may take place inline upstream from a mixing unit 210, which advantageously could be or could comprise equipment a static mixer or mixing block, offering the possibility of substantially simpler equipment as compared to a mechanically agitated mixing pot.

As shown in FIG. 2, a catalyst slurry is again provided from first vessel 102 into line 104, and a catalyst solution is again provided from second vessel 106 into line 108. Instead of being directly supplied to a mixing unit 210, at least a portion of the catalyst solution in line 108 is diverted to line 104 via line 116 (i.e., a “jumpover line”), wherein pre-mixing of the catalyst slurry and the catalyst solution may take place in a downstream portion 104a of line 104, prior to entering static mixer or mixing block 210. Optionally, all of the catalyst solution in line 108 need not necessarily be diverted to line 104 through line 116, and a portion of the catalyst solution may instead be directed to mixing unit 210. Downstream portion 104a includes the portion of line 104 located between the mixing unit 210 and the union of line 116 with line 104. A slurry pump (not shown in FIG. 2) may be located immediately upstream from downstream portion 104a to maximize the contact time in downstream portion 104a. In non-limiting examples, the catalyst slurry and the catalyst solution may have a contact time of at least about 5 minutes (or at least about 6 minutes, such as at least about 7 minutes) within downstream portion 104a, and the contact time may be further adjusted through choice of the location at which line 116 intersects with line 104. A total (combined) contact time of the catalyst slurry and the catalyst solution in downstream portion 104a and mixing unit 210 may be at least about double that obtained without downstream portion 104a of line 104 being present (e.g., when the catalyst slurry and the catalyst solution are introduced directly to a mixing unit 210) and/or the total contact time may increase by at least about 4 minutes relative to that obtained without downstream portion 104a of line 104 being present (e.g., when the catalyst slurry and the catalyst solution are introduced directly to mixing unit 210). In more specific non-limiting examples, the total contact time within downstream portion 104a and mixing unit 210 may be at least about 6 minutes, or at least about 7 minutes when downstream portion 104a of line 104 is present (such as within a range from 6, 7, or 8 minutes to 7, 8, 9, or 10 minutes; with ranges from any foregoing low to any foregoing high contemplated, provided the high end is greater than the low end; such as 6-7 minutes).

After a modified catalyst slurry has been obtained from mixing unit 210, the modified catalyst slurry may be conveyed to reactor 114 via line 112, as described above in reference to FIG. 1 (again noting that line 112 could be replaced with multiple parallel line(s) 112, as described above in connection with FIG. 1). Optionally, one or more static mixers 115 may reside within line 112, which may provide additional contact time for mixing, if needed.

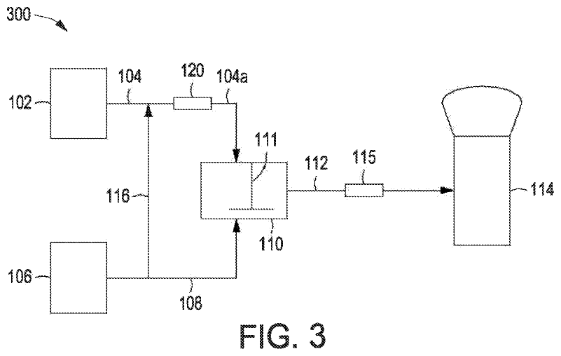

In yet another example, inline mixing of a catalyst slurry and a catalyst solution may be employed in combination with a mechanically agitated mixing pot to afford an even greater contact time (e.g., such that mixing unit 210 is or comprises a mechanically agitated mixing pot such as mixing pot 110 of FIG. 1). An example of such a system is shown in FIG. 3. FIG. 3 is a block diagram schematic of gas-phase reactor system 300, in which mixing of a catalyst slurry and a catalyst solution may take place inline upstream from a mechanically agitated mixing pot. Reactor system 300 may be obtained in instances wherein the mixing unit 210 of reactor system 200 is specifically a mechanically agitated mixing pot, such as mixing pot 110 of reactor system 100, having one or more impellers 111. Optionally, one or more static mixers or mixing blocks 120 may additionally be placed within line 104a to provide additional contact time for mixing, if needed, upstream from the mechanically agitated mixing pot 110. In such embodiments, contact time between catalyst slurry and catalyst solution in the downstream portion of line 104a may be as described above in connection with FIG. 2, such as at least about 5, 6, or 7 minutes; and contact time in the agitated mixing pot 110 may additionally be as described in connection with FIG. 1, such as 30-40 minutes; or more generally from a low of any one of 20, 22, 25, 27, 28, or 30 minutes to a high of any one of about 30, 33, 35, 37, 38, 39, 40, 42, 45, or 50 minutes, with total contact time being the sum of line 104a contact time and mixing pot 110 contact time.

The modified catalyst slurry can be introduced into the polymerization reactor via a single line in fluid contact with the polymerization reactor or via two or more lines in fluid contact with the polymerization reactor, such as 2, 3, 4, or more lines. It is also contemplated that multiple modified catalyst slurries having different compositions may be introduced via two or more lines in fluid contact with the polymerization reactor. Such lines may include specialized equipment used for conveying the modified catalyst slurry/slurries through the line and into the polymerization reactor. Examples of such specialized equipment include, but are not limited to, pinch valves, nozzles such as spray nozzles and solid stream nozzles, temperature controllers, the like, and any combination thereof. The specialized equipment may be used to control the uniformity of the catalyst entering the reactor. The line(s) entering the polymerization reactor may be temperature controlled either upstream of the specialized equipment or within the equipment itself. The temperature controls may aid in regulating the viscosity of the modified catalyst slurry and limit temperature variability within the reactor as a consequence of the modified catalyst slurry/slurries entering the polymerization reactor at different rates. When multiple lines are present, each line may be operated with independent flow control and/or independent temperature control.

Summarizing more generally, a modified catalyst slurry and one or more olefins, among other potential streams, may be introduced into a polymerization reactor, preferably a gas-phase reactor, more preferably a fluidized bed gas-phase reactor. The modified catalyst slurry may be obtained by combining an initial catalyst slurry containing a supported catalyst comprising at least one catalyst compound with a catalyst solution comprising a first catalyst compound already contained upon the supported catalyst and/or a second catalyst compound not already contained upon the supported catalyst. The supported catalyst may further comprise at least one activator upon a support material, in addition to the at least one catalyst compound. The catalyst slurry and the catalyst solution may each comprise a carrier liquid suitable for conveying the supported catalyst and catalyst compound(s) therein, and in which contact between the supported catalyst of the catalyst slurry and the catalyst compound(s) of the catalyst solution may take place. The carrier liquid in the catalyst slurry and the catalyst solution may be the same or different. By contacting the catalyst slurry with the catalyst solution, a different catalyst compound may be introduced onto the support material and/or the loading of at least one catalyst compound upon the support material may be increased. Upon contacting the activator upon the support material, a modified catalyst slurry having modulated activity for conducting a polymerization reaction may be obtained. In non-limiting examples, the modified catalyst slurry may be less prone to sheeting during the polymerization as a direct consequence of the increased contact time between the catalyst slurry and the catalyst solution afforded by the disclosure herein. The contact time may be further selected to decrease the degree of polymer sheeting to a desired degree.

Accordingly, some methods for increasing contact time between a catalyst slurry and a catalyst solution according to the present disclosure may comprise: providing a catalyst slurry comprising a supported catalyst, the supported catalyst comprising a support material, at least one catalyst compound, and at least one activator; introducing the catalyst slurry to a first line in fluid communication with a mechanically agitated mixing pot; introducing at least a first portion of a catalyst solution to a second line in fluid communication with the mechanically agitated mixing pot, the catalyst solution comprising a first catalyst compound already contained upon the supported catalyst or a second catalyst compound different from the first catalyst compound and not contained upon the supported catalyst; contacting the catalyst slurry with the catalyst solution in the mechanically agitated mixing pot to obtain a modified catalyst slurry from the mechanically agitated mixing pot, the modified catalyst slurry comprising a modified supported catalyst incorporating at least a portion of the first catalyst compound or the second catalyst compound from the catalyst solution; feeding the modified catalyst slurry to a fluidized bed gas-phase reactor; and polymerizing an α-olefin in the fluidized bed gas-phase reactor under polymerization conditions to obtain a polyolefin.

In some or other embodiments, methods for increasing contact time between a catalyst slurry and a catalyst solution according to the present disclosure may comprise: providing a catalyst slurry comprising a supported catalyst, the supported catalyst comprising a support material, at least one catalyst compound, and at least one activator; introducing the catalyst slurry to a line in fluid communication with a mixing unit; introducing at least a first portion of a catalyst solution to the line upstream from the mixing unit, the catalyst solution comprising a first catalyst compound already contained upon the supported catalyst or a second catalyst compound different from the first catalyst compound and not already contained upon the supported catalyst; contacting the catalyst slurry with the catalyst solution in the line and in the mixing unit to obtain a modified catalyst slurry from the mixing unit, the modified catalyst slurry comprising a modified supported catalyst incorporating at least a portion of the first catalyst compound or the second catalyst compound from the catalyst solution, feeding the modified catalyst slurry to a fluidized bed gas-phase reactor; and polymerizing an α-olefin in the fluidized bed gas-phase reactor under polymerization conditions to obtain a polyolefin.

As noted above in connection with FIGS. 2 and 3, to enhance the mixing efficiency prior to polymerization (i.e., to increase the contact time of the catalyst-containing mixtures), the catalyst-containing mixtures may be further contacted in-line upstream from the mixing unit by utilizing a jumpover line. The jumpover line may comprise tubing or piping in which at least a portion of the catalyst-containing mixtures are diverted for pre-mixing upstream from the mixing unit (e.g., a static mixer or mixing block, or even a mechanically agitated mixing pot). For example, the jumpover line may facilitate contact times between the catalyst-containing mixtures before entering the mixing unit of about 4, 5, or 6 minutes to about 6, 7, 8, 9, or 10 minutes.

When utilizing a jumpover line, in one or more aspects, the mixing unit may comprise a static mixer, a mixing block, a mechanically agitated mixing pot, or any combination thereof. When a mechanically agitated mixing pot is used instead of a static mixer or mixing block, the contact time of the catalyst-containing mixtures may increase to about 30 minutes to about 40 minutes, or about 30 minutes to about 35 minutes, or about 35 minutes to about 40 minutes, in addition to the increased in-line contact time afforded by the jumpover line (fora total of, e.g., 35, 36, or 37 minutes to 45, 46, 47, 48, 49, or 50 minutes). In one or more aspects, such as those in accordance with FIG. 1 as described above, a mechanically agitated mixing pot may be utilized without a jumpover line also being present. Similar contact times between the catalyst-containing mixtures in the mechanically agitated mixing pot may be utilized.

Implementation of a jumpover line, a mechanically agitated mixing pot, or a combination thereof may substantially reduce the amount of polymer sheeting in the polymerization reactor. For instance, the rate of polymer sheeting in the polymerization reactor may be ≤0.3%. In various embodiments, the polymer sheeting rate may be ≤0.3%, ≤0.27%, ≤0.25%, ≤0.23%, ≤0.2%, ≤0.17%, ≤0.15%, ≤0.13%, ≤0.1%, ≤0.09%, ≤0.8%, ≤0.07%, ≤0.06%, ≤0.05%, or ≤0.04%. The polymer sheeting rate refers to the percentage mass of sheeted polymer produced relative to the total amount of polymer produced over a given length of time. The reduction in the rate of polymer sheeting may decrease the frequency of sheeting removal downstream from the reactor. Accumulated polymer sheeting may not need to be removed from a collection bin in communication with the polymerization reactor for up to 48 hours, or up to about 36 hours, or up to about 24 hours, or up to about 12 hours, or up to about 6 hours, for example.

### Catalyst Slurry, Catalyst Solution, and Modified Catalyst Slurry

The catalyst slurry and the modified catalyst slurry can include at least a carrier liquid and at least one catalyst compound upon a supported catalyst. Optionally, the catalyst slurry may further include one or more waxes, mineral oil, induced condensing agents, or any combination thereof. In some embodiments, the carrier liquid may be or can include, but is not limited to, one or more mineral oils and/or one or more waxes, optionally in further combination with an induced condensing agent.

It is also noted that some components present within the polymerization reactor may be fed to the reactor via the modified catalyst slurry (e.g., the optional induced condensing agent, a carrier fluid, such as nitrogen, or the like) or may additionally or alternately be fed to the reactor via other means. For example, induced condensing agents in gas-phase polymerization processes, and in particular fluidized bed gas phase polymerization processes, may be provided to the process in a cycle gas flowing up through the fluidized bed in the polymerization reactor, or they may also be provided in other streams that are not the modified catalyst slurry or the cycle gas. Cycle gas may refer to a gas stream comprising an olefinic feed that is circulated through the reactor and replenished with additional olefins when needed.

In some embodiments, the catalyst slurry or the modified catalyst slurry can include 1 wt %, 5 wt %, 8 wt %, or 10 wt % to 15 wt %, 20 wt %, 25 wt %, 30 wt %, 35 wt %, or 40 wt % of solids, based on a total weight of the catalyst slurry or modified catalyst slurry. The solids include the catalyst compound(s), a support material, an activator, and, if present, any other solid component(s). The wax, if present in the carrier liquid, is considered a liquid component and not a solid component. For example, if the catalyst slurry or modified catalyst slurry includes a first catalyst, a second catalyst, a support, an activator, and the carrier liquid that includes a mineral oil and a wax, the solid components include the first and second catalysts, the support, and the activator; and the liquid components include the mineral oil and the wax.

The modified catalyst slurry can include a first catalyst compound and a second catalyst compound, wherein the first catalyst compound is capable of producing a high molecular weight polymer and a second catalyst compound is capable of producing a low molecular weight. In other words, the first catalyst compound can be one that makes primarily high molecular-weight polymer chains, and the second catalyst compound makes primarily low molecular-weight polymer chains, which may be dependent upon the catalyst structure and conducting the polymerization reaction under specified polymerization conditions. Thus, in some examples, the polymer product produced under the polymerization conditions by the modified catalyst slurry may comprise both the high- and low-molecular weight polymers. The two catalyst compounds can be present in the modified catalyst slurry in a molar ratio of the first catalyst compound to the second catalyst compound of 99:1 to 1:99, 90:10 to 10:90, 85:15 to 15:85, 75:25 to 25:75, 60:40 to 40:60, 55:45 to 45:55 In some embodiments, the first catalyst compound and/or the second catalyst compound can also be added to the catalyst slurry as a trim catalyst from a catalyst solution to adjust the molar ratio of the first catalyst compound to the second catalyst compound. In at least one embodiment, the first catalyst compound and the second catalyst compound can each be a metallocene catalyst, as described further below.

The terms “slurry catalyst” or “catalyst slurry” each refer to a contact product comprising a dispersed supported catalyst that includes at least one catalyst compound upon a support, a carrier liquid, and an activator, and an optional co-activator. In particular embodiments, the slurry catalyst may include two catalyst compounds, such as two metallocene catalyst compounds, particularly after formation of a modified catalyst slurry. For instance, the modified slurry catalyst may include a supported catalyst comprising a first metallocene and a second metallocene that are each different from the other in at least one structural aspect. Additional disclosure on suitable catalyst compounds is provided further below.

As just noted, one or more induced condensing agents (ICAs) can be introduced into the reactor; such ICAs can increase the production rate of polymer product. ICA may be present in the catalyst slurry, the catalyst solution, or the modified catalyst slurry resulting from contacting the catalyst slurry with the catalyst solution. Alternately, at least a portion of the ICA may be combined with the modified catalyst slurry in the line leading from the mixing device to the reactor (e.g., in line(s) 112 as illustrated in FIGS. 1-3), or the ICA can be introduced to the reactor independently of the catalyst slurry. The ICA can be condensable under the polymerization conditions within the polymerization reactor. The introduction of an ICA into the reactor is often referred to as operating the reactor in “condensed mode.” The ICA can be non-reactive in the polymerization process, but the presence of the ICA can increase the production rate of the polymer product. In some embodiments, the ICA agent can be or can include, but is not limited to, one or more alkanes. Illustrative alkanes can be or can include, but are not limited to, propane, n-butane, isobutane, n-pentane, isopentane, neopentane, n-hexane, isohexane, n-heptane, n-octane, or any mixture thereof. Further details on ICAs can be found in U.S. Pat. Nos. 5,352,749; 5,405,922; 5,436,304; and 7,122,607; and International Patent Application Publication Number WO 2005/113615(A2). As noted, such ICA(s) can be added to the modified catalyst slurry in-line; this may be the main source of ICA provided to the reactor, or may be in addition to any other ICA separately introduced to the reactor, e.g., through recycle gas introduced to the reactor. The induced condensing agent can be introduced to the modified catalyst slurry at a rate of or, when multiple lines are used, at an average rate of about 0.4 kg/hr, 1 kg/hr, 5 kg/hr, or 8 kg/hr to 11 kg/hr, 23 kg/hr, or 45 kg/hr per line.

When the catalyst slurry or modified catalyst slurry also includes an induced condensing agent, the induced condensing agent may constitute 30 to 90 wt % of the catalyst slurry or modified catalyst slurry by weight, such as 30, 35, 40, 45, or 50 wt % to 60, 70, 80, or 90 wt % of the catalyst slurry or modified catalyst slurry by weight. In some embodiments, when the catalyst slurry or modified catalyst slurry also includes a mineral oil and a wax in addition to the induced condensing agent, the mineral oil may constitute from a low of 8, 15, 20, or 25 wt % to a high of 40, 50, 60, or 68 wt % of the catalyst slurry or modified catalyst slurry, the wax may constitute from a low of 2, 5, or 7 wt % to a high of 10, 12, or 15 wt % of the catalyst slurry or modified catalyst slurry, and the induced condensing agent may constitute from a low of 30, 40, 45, or 50 wt % to a high of 60, 70, 80, or 90 wt % of the catalyst slurry or modified catalyst slurry, each based on the total mass of the catalyst slurry or modified catalyst slurry.

The wax, if present, can increase the viscosity of the catalyst-containing mixture. As used herein, the term “wax” includes a petrolatum also known as petroleum jelly or petroleum wax. Petroleum waxes include paraffin waxes and microcrystalline waxes, which include slack wax and scale wax. Commercially available waxes include SONO JELL® paraffin waxes, such as SONO JELL® 4 and SONO JELL® 9, available from Sonneborn, LLC. In at least one embodiment, the wax, if present, can have a density (at 100° C.) of 0.7 g/cm³, 0.73 g/cm³, or 0.75 g/cm³ to 0.87 g/cm³, 0.9 g/cm³, or 0.95 g/cm³. The wax, if present, can have a kinematic viscosity at 100° C. of 5 cSt, 10 cSt, or 15 cSt to 25 cSt, 30 cSt, or 35 cSt. The wax, if present, can have a melting point of 25° C., 35° C., or 50° C. to 80° C., 90° C., or 100° C. The wax, if present can have a boiling point of 200° C. or greater, 225° C. or greater, or 250° C. or greater.

It should be understood that the term “wax” also refers to or otherwise includes any wax not considered a petroleum wax, which include animal waxes, vegetable waxes, mineral fossil or earth waxes, ethylenic polymers and polyol ether-esters, chlorinated naphthalenes, and hydrocarbon type waxes. Animal waxes can include beeswax, lanolin, shellac wax, and Chinese insect wax. Vegetable waxes can include carnauba, candelilla, bayberry, and sugarcane. Fossil or earth waxes can include ozocerite, ceresin, and montan. Ethylenic polymers and polyol ether-esters include polyethylene glycols and methoxypolyethylene glycols. The hydrocarbon type waxes include waxes produced via Fischer-Tropsch synthesis.

In some embodiments, the catalyst slurry, the catalyst solution, or the modified catalyst slurry can be free of any wax having a melting point of ≥25° C. In other embodiments, the catalyst slurry, the catalyst solution, or the modified catalyst slurry can include ≤3 wt %, ≤2.5 wt %, ≤2 wt %, ≤1.5 wt %, ≤1 wt %, ≤0.9 wt %, ≤0.8 wt %, ≤0.7 wt %, ≤0.6 wt %, ≤0.5 wt %, ≤0.4 wt %, ≤0.3 wt %, ≤0.2 wt %, or ≤0.1 wt % of any wax having a melting point of ≥25° C., based on a total mass of the catalyst slurry, the catalyst solution, or the modified catalyst slurry.

In various embodiments, an aluminum alkyl, an ethoxylated aluminum alkyl, an alumoxane, an anti-static agent (such anti-static agents are referenced in Paragraphs [0078]-[0082] of WO2022/174202) or a borate activator, such as a C₁ to C₁₅ alkyl aluminum (for example tri-isobutyl aluminum, trimethyl aluminum or the like), a C₁ to C₁₅ ethoxylated alkyl aluminum or methyl aluminoxane, ethyl aluminoxane, isobutylaluminoxane, modified aluminoxane or the like can be added in-line to the modified catalyst slurry. For example, the alkyls, antistatic agents, borate activators and/or alumoxanes can be added from a vessel directly to the modified catalyst slurry in-line. The additional alkyls, antistatic agents, borate activators and/or alumoxanes can be present in an amount of 1 ppm, 10 ppm, 50 ppm, 75 ppm, or 100 ppm to 200 ppm, 300 ppm, 400 ppm, or 500 ppm. In some embodiments, an optional carrier fluid such as molecular nitrogen, argon, ethane, propane, and the like, can be added in-line to the modified catalyst slurry. The carrier fluid, e.g., molecular nitrogen, can be introduced through a line at a rate of (or, when multiple lines are used, at an average rate of) about 0.4 kg/hr, 1 kg/hr, 5 kg/hr, or 8 kg/hr to 11 kg/hr, 23 kg/hr, or 45 kg/hr per line. In other embodiments, the carrier fluid can be introduced through the line at a rate of or, when multiple lines are used, at an average rate of about 5 kg/hr, 7 kg/hr, 9 kg/hr, or 10 kg/hr to 11 kg/hr, 13 kg/hr, or 15 kg/hr per line.

In some embodiments (not directly shown in FIG. 1, 2, or 3), a carrier fluid, such as molecular nitrogen, monomer, or other materials can be introduced to the modified catalyst slurry after mixing the catalyst solution and the catalyst slurry. The introduction can take place along the line leading to the gas-phase polymerization reactor or in an injection nozzle, which can include a support tube that can at least partially surround an injection nozzle. The modified catalyst slurry can be passed through the injection nozzle into the reactor. In various embodiments, the injection nozzle can aerosolize the catalyst-containing mixture. Any number of suitable tubing sizes and configurations can be used to aerosolize and/or inject the slurry/solution mixture.

In some configurations, a carrier fluid may be split off or otherwise sourced, directly or indirectly, from cycle gas (e.g., all or a portion of the cycle gas). In this case, where cycle gas is used as a carrier fluid, the skilled artisan might appreciate that such cycle gas could also include induced condensing agent. The cycle gas may comprise at least a portion of a polymerization feed being recycled through the gas-phase polymerization reactor.

In some embodiments, the modified catalyst slurry can include 1 wt %, 5 wt %, 10 wt %, or 15 wt % to 25 wt %, 30 wt %, 35 wt %, or 40 wt % of the one more catalyst compounds, based on a total weight of the modified catalyst slurry. The foregoing weight percentages do not include the support material upon which the catalyst is disposed. In such embodiments, a total amount of the modified catalyst slurry introduced into the reactor can be at a flow rate of ≥0.1 kg/hr per cubic meter of polymerization reactor volume ≥0.11 kg/hr per cubic meter of polymerization reactor volume, ≥0.12 kg/hr per cubic meter of polymerization reactor volume, 0.13 kg/hr per cubic meter of polymerization reactor volume or ≥0.14 kg/hr per cubic meter of polymerization reactor volume to 0.2 kg/hr per cubic meter of polymerization reactor volume, 0.3 kg/hr per cubic meter of polymerization reactor volume, 0.4 kg/hr per cubic meter of polymerization reactor volume, or 0.5 kg/hr per cubic meter of polymerization reactor volume.

In some embodiments, to promote formation of particles in the reactor, a nucleating agent, such as silica, alumina, fumed silica or other suitable particulate matter can be added directly into the reactor. Alternatively, a nucleating agent may be present in the catalyst solution, the catalyst slurry, and/or the modified catalyst slurry, optionally with further introduction of nucleating agent to the reactor also taking place. Advantageously, nucleating agent may be optional in the disclosure herein, but may be included, if desired. Preferably, a nucleating agent is excluded from the catalyst solution and the catalyst slurry and/or when mixing the catalyst solution and the catalyst slurry (that is, nucleating agent, if any, is introduced into the modified catalyst slurry in line(s) downstream from any mixing unit (mechanically agitated mixing pot, static mixer, mixing block, etc.). For embodiments that do not include a nucleating agent, it has been discovered that a high polymer bulk density (e.g., 0.4 g/cm³ or greater) can be obtained, which is greater than the bulk density of polymers formed by conventional trim processes. Furthermore, when a metallocene catalyst or other similar catalyst is used in the gas phase reactor, oxygen or fluorobenzene can be added to the reactor directly or to the gas stream (including carrier fluid) in-line to control the polymerization rate. Thus, when a metallocene catalyst (which is sensitive to oxygen or fluorobenzene) is used in combination with another catalyst (that is not sensitive to oxygen) in a gas phase reactor, oxygen can be used to modify the metallocene polymerization rate relative to the polymerization rate of the other catalyst. WO 1996/009328 discloses the addition of water or carbon dioxide to gas phase polymerization reactors, for example, for similar purposes.

### Catalyst Compounds

The methods of the present disclosure can be employed generally with any catalyst system including at least one catalyst compound localized on a support, preferably two or more catalyst compounds localized on a support once a modified supported catalyst has been formed. In particular examples, the supported catalyst in a catalyst slurry may contain a first catalyst compound on a support, and a second catalyst compound different from the first catalyst compound may be delivered from a catalyst solution to the catalyst slurry to form a modified catalyst slurry according to the disclosure herein.

As a particular example, the catalyst compounds can include one or more metallocenes. In some embodiments, the catalyst can include first and second catalyst compounds that are at least a first metallocene and a second metallocene, where the first and second metallocenes have different chemical structures from one another Metallocenes can include structures having one or more Cp ligands (cyclopentadienyl and ligands isolobal to cyclopentadienyl) bound to at least one Group 3 to Group 12 metal atom, and one or more leaving group(s) bound to the at least one metal atom.

Suitable metallocene catalysts may include those described in US Patent Application Publications 2019/0119413 and 2019/0119417, which are incorporated herein by reference. Also suitable are catalyst systems employing a mix of two metallocene catalysts such as those described in US Patent Application Publication 2020/0071437, such as a mix of (1) a bis-cyclopentadienyl hafnocene and (2) a zirconocene, such as an indenyl-cyclopentadienyl zirconocene. Additional details are provided hereinafter.

More particularly, the bis-cyclopentadienyl hafnocene may be in accordance with one or more of the metallocenes according to formulas (A1) and/or (A2) as described in US2020/0071437, for instance, those per formula (A1) as described in Paragraphs [0069]-[0086] of US2020/0071437, or those per formula (A2) as described in Paragraphs [0086]-[0101] of US2020/0071437, which descriptions are incorporated herein by reference.

Particular examples of hafnocenes according to formula (A1) include bis(n-propylcyclopentadienyl)hafnium dichloride, bis(n-propylcyclopentadienyl)hafnium dimethyl, (n-propylcyclopentadienyl, pentamethylcyclopentadienyl)hafnium dichloride, (n-propylcyclopentadienyl, pentamethylcyclopentadienyl)hafnium dimethyl, (n-propylcyclopentadienyl, tetramethylcyclopentadienyl)hafnium dichloride, (n-propylcyclopentadienyl, tetramethylcyclopentadienyl)hafnium dimethyl, bis(cyclopentadienyl)hafnium dimethyl, bis(n-butylcyclopentadienyl)hafnium dichloride, bis(n-butylcyclopentadienyl)hafnium dimethyl, and bis(1-methyl-3-n-butylcyclopentadienyl)hafnium dimethyl.

Hafnocene compounds according to (A2) that are particularly useful include one or more of the compounds listed in Paragraph [0101] of US2020/0071437, also incorporated by reference herein, such as (for a relatively brief example): rac/meso Me₂Si(Me₃SiCH₂Cp)₂HfMe₂; racMe₂Si(Me₃SiCH₂Cp)₂HfMe₂; rac/meso Ph₂Si(Me₃SiCH₂Cp)₂HfMe₂; rac/meso (CH₂)₃Si(Me₃SiCH₂Cp)₂HfMe₂; rac/meso (CH₂)₄Si(Me₃SiCH₂Cp)₂HfMe₂; rac/meso (C₆F₅)₂Si(Me₃SiCH₂Cp)₂HfMe₂; rac/meso (CH₂)₃Si(Me₃SiCH₂Cp)₂ZrMe₂; rac/meso Me₂Ge(Me₃SiCH₂Cp)₂HfMe₂; rac/meso Me₂Si(Me₂PhSiCH₂Cp)₂Hf Me₂; rac/meso Ph₂Si(Me₂PhSiCH₂Cp)₂HfMe₂; Me₂Si(Me₄Cp)(Me₂PhSiCH₂Cp)HfMe₂; etc.

Accordingly, in a particular example, the first catalyst compound upon the support material may comprise a first metallocene that is a hafnocene, such as a rac/meso dimethylsilylbis[((trimethylsilyl)methyl)cyclopentadienyl] hafnium dimethyl. The second catalyst compound in the catalyst solution may comprise a second metallocene that is different than the first metallocene. The second metallocene may comprise a zirconocene, as described hereinafter.

Suitable catalyst compounds may include a zirconocene, such as a zirconocene according to formula (B) as described in Paragraphs [0103]-[0113] of US2020/0071437, which description is also incorporated herein by reference. Particular examples of suitable zirconocenes may be any one or more of those listed in Paragraph [0112] of US2020/0071437, e.g.: bis(indenyl)zirconium dichloride, bis(indenyl)zirconium dimethyl, bis(tetrahydro-1-indenyl)zirconium dichloride, bis(tetrahydro-1-indenyl)zirconium dimethyl, rac/meso-bis(1-ethylindenyl)zirconium dichloride, rac/meso-bis(1-ethylindenyl)zirconium dimethyl, rac/meso-bis(1-methylindenyl)zirconium dichloride, rac/meso-bis(1-methylindenyl)zirconium dimethyl, rac/meso-bis(1-propylindenyl)zirconium dichloride, rac/meso-bis(1-propylindenyl)zirconium dimethyl, rac/meso-bis(1-butylindenyl)zirconium dichloride, rac/meso-bis(1-butylindenyl)zirconium dimethyl, meso-bis(1ethylindenyl) zirconium dichloride, meso-bis(1-ethylindenyl) zirconium dimethyl, (1-methylindenyl)(pentamethyl cyclopentadienyl) zirconium dichloride, (1-methylindenyl)(pentamethyl cyclopentadienyl) zirconium dimethyl, or combinations thereof.

Accordingly, in particular examples, the second catalyst compound may comprise a second metallocene that is a zirconocene, such as a rac/meso bis(1-methylindenyl) zirconium dimethyl.

As noted above, the supported catalyst and/or the modified supported catalyst can include one or more activators and/or supports in addition to one or more catalyst compounds. The term “activator” refers to any compound or combination of compounds, supported or unsupported, which can activate a single site catalyst compound or component, such as by creating a cationic species of the catalyst component. For example, this can include the abstraction of at least one leaving group from the metal center of the single site catalyst compound/component. The activator may also be referred to as a “co-catalyst.” For example, the supported catalyst or modified supported catalyst within the slurry catalyst or modified slurry catalyst mixture can include two or more activators (such as alumoxane and a modified alumoxane) and at least one catalyst compound, such as a first catalyst compound and a second catalyst compound. In particular embodiments, the slurry catalyst or modified slurry catalyst can include at least one support, at least one activator, and at least two catalyst compounds. For example, the slurry can include at least one support, at least one activator, and two different catalyst compounds that can be added separately or in combination to produce the slurry catalyst or modified slurry catalyst. In some embodiments, a mixture of a support, e.g., silica, and an activator, e.g., alumoxane, can be contacted with a catalyst compound, allowed to react, and thereafter the mixture can be contacted with another catalyst compound from a catalyst solution to form a modified supported catalyst within a modified catalyst slurry according to the disclosure herein.

The molar ratio of metal or non-coordinating anion in the activator to metal in the catalyst compound(s) in the slurry catalyst can be 1000.1 to 0.5:1, 300:1 to 1:1, 100:1 to 1:1, or 150:1 to 1:1 The support material for the supported catalyst can be any inert particulate carrier material known in the art, including, but not limited to, silica, fumed silica, alumina, clay, talc or other support materials such as disclosed above. In one embodiment, the supported catalyst can include silica and an activator, such as methyl alumoxane (“MAO”), modified methyl alumoxane (“MMAO”), or the like. Preferred activators typically include alumoxane compounds, modified alumoxane compounds, and ionizing anion precursor compounds that abstract a reactive, σ-bound, metal ligand making the metal compound cationic and providing a charge-balancing non-coordinating or weakly coordinating anion. For instance, suitable activators may include any of the alumoxane activators and/or ionizing/non-coordinating anion activators described in Paragraphs [0118]-[0128] of US2020/0071437, also incorporated herein by reference.

Suitable supports include, but are not limited to, active and inactive materials, synthetic or naturally occurring zeolites, as well as inorganic materials such as clays and/or oxides such as silica, alumina, zirconia, titania, silica-alumina, cerium oxide, magnesium oxide, or combinations thereof. In particular, the support may be silica-alumina, alumina and/or a zeolite, particularly alumina. Silica-alumina may be either naturally occurring or in the form of gelatinous precipitates or gels including mixtures of silica and metal oxides. Suitable supports may include any of the support materials described in Paragraphs [0129]-[0131] of US2020/0071437, which description is also incorporated by reference herein; wherein Al₂O₃, ZrO₂, SiO₂ and combinations thereof are particularly noted.

### Catalyst Solution

The catalyst solution can include a solvent or diluent and only catalyst compound(s), such as a metallocene, or can also include an activator. The at least one catalyst compound in the catalyst solution may be unsupported in a particular example. Preferably, the catalyst solution can be prepared by dissolving the at least one catalyst compound and an optional activator in the solvent or diluent. In some embodiments, the diluent or solvent can be an alkane, such as a C₅ to C₃₀ alkane, or a C₅ to C₁₀ alkane. Cyclic alkanes such as cyclohexane and aromatic compounds such as toluene can also be used. Mineral oil can be also used as the diluent alternatively or in addition to other alkanes such as one or more C₅ to C₃₀ alkanes. The mineral oil in the catalyst solution, if used, can have the same properties as the mineral oil that can be used to make the catalyst slurry.

The diluent or solvent employed can be liquid under the conditions of polymerization and relatively inert. In one embodiment, the diluent utilized in the catalyst solution can be different from the diluent used in the catalyst slurry. In another embodiment, the solvent utilized in the catalyst solution can be the same as the diluent, i.e., the mineral oil(s) and any additional diluents used in the catalyst slurry. Hydrocarbon solvents may also function as induced condensing agents during the polymerization reaction in some cases.

If the catalyst solution includes both the catalyst and an activator, the ratio of metal or non-coordinating anion in the activator to metal in the catalyst in the catalyst solution can be 1000:1 to 0.5:1, 300:1 to 1:1, or 150:1 to 1:1. In various embodiments, the activator and catalyst can be present in the catalyst solution at up to about 90 wt %, at up to about 50 wt %, at up to about 20 wt %, such as at up to about 10 wt %, at up to about 5 wt %, at less than 1 wt %, or between 100 ppm and 1 wt %, based on the weight of the diluent, the activator, and the catalyst. The one or more activators in the catalyst solution, if used, can be the same or different as the one or more activators present in the catalyst slurry upon the supported catalyst.

### Polymerization Conditions and Polyolefin Product

Once a modified catalyst slurry has been produced according to the disclosure above, the modified catalyst slurry may be fed to a polymerization reaction in combination with an olefinic feed under suitable polymerization conditions to obtain a polyolefin. In non-limiting examples, the olefinic feed may comprise at least one α-olefin to afford a polyolefin homopolymer or copolymer.

Monomers useful herein include substituted or unsubstituted C₂ to C₄₀ alpha olefins, such as C₂ to C₂₀ alpha olefins, such as C₂ to C₁₂ alpha olefins, such as ethylene, propylene, butene, pentene, hexene, heptene, octene, nonene, decene, undecene, dodecene and isomers thereof. In at least one embodiment, the monomer can include ethylene and one or more optional comonomers selected from C₃ to C₄₀ olefins, such as C₄ to C₂₀ olefins, such as C₆ to C₁₂ olefins. Suitable C₄ to C₄₀ olefin monomers can be linear, branched, or cyclic. The C₄ to C₄₀ cyclic olefins may be strained or unstrained, monocyclic or polycyclic, and may optionally include heteroatoms and/or one or more functional groups. In at least one embodiment, the monomer can include ethylene and an optional comonomer that can include one or more C₃ to C₄₀ olefins, such as C₄ to C₂₀ olefins, such as C₆ to C₁₂ olefins.

In some embodiments, the C₂ to C₄₀ alpha olefin monomer and optional comonomer(s) include ethylene, propylene, butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, such as hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, such as norbornene, norbornadiene, and dicyclopentadiene.

In at least one embodiment, one or more dienes can be present in the polymer product at up to 10 wt %, such as at 0.00001 wt % to 1.0 wt %, such as 0.002 wt % to 0.5 wt %, such as 0.003 wt % to 0.2 wt %, based upon the total weight of the composition. In at least one embodiment 500 ppm or less of diene is added to the polymerization, such as 400 ppm or less, such as 300 ppm or less. In other embodiments at least 50 ppm of diene is added to the polymerization, or 100 ppm or more, or 150 ppm or more.

Diene monomers include any hydrocarbon structure, such as C₄ to C₃₀, having at least two unsaturated bonds, where at least two of the unsaturated bonds are readily incorporated into a polymer by either a stereospecific or a non-stereospecific catalyst(s). The diene monomers can be selected from alpha, omega-diene monomers (i.e., di-vinyl monomers). The diolefin monomers are linear di-vinyl monomers, such as those containing from 4 to 30 carbon atoms. Examples of dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Cyclic dienes include cyclopentadiene, vinylnorbornene, norbornadiene, ethylidene norbornene, divinylbenzene, dicyclopentadiene or higher ring containing diolefins with or without substituents at various ring positions.

The temperature within the reactor can be greater than 30° C., greater than 40° C., greater than 50° C., greater than 90° C., greater than 100° C., greater than 110° C., greater than 120° C., greater than 150° C., or higher. In general, the reactor can be operated at a suitable temperature taking into account the sintering temperature of the polymer product being produced within the reactor. Thus, the upper temperature limit in one embodiment can be the melting temperature of the polymer product produced within in the reactor. However, higher temperatures can result in narrower molecular weight distributions that may be further improved by the addition of a catalyst or other co-catalysts.

In some embodiments, hydrogen gas can be used in the polymerization process to help control or otherwise adjust the final properties of the polyolefin, such as described in the “Polypropylene Handbook, at pages 76-78 (Hanser Publishers, 1996). Using certain catalyst systems, increasing concentrations (partial pressures) of hydrogen can increase a flow index such as the melt index of the polyethylene polymer. The melt index can thus be influenced by the hydrogen concentration. The amount of hydrogen in the polymerization can be expressed as a mole ratio relative to the total polymerizable monomer, for example, ethylene, or a blend of ethylene and hexene or propylene.

The amount of hydrogen used in the polymerization process can be an amount necessary to achieve the desired melt index of the final polyolefin polymer. For example, the mole ratio of hydrogen to total monomer (H₂:monomer) can be 0.0001 or greater, 0.0005 or greater, or 0.001 or greater. Further, the mole ratio of hydrogen to total monomer (H₂:monomer) can be 10 or less, 5 or less, 3 or less, or 0.10 or less. A range for the mole ratio of hydrogen to monomer can include any combination of any upper mole ratio limit with any lower mole ratio limit described herein. The amount of hydrogen in the reactor at any time can range to up to 5,000 ppm, up to 4,000 ppm in another embodiment, up to 3,000 ppm, or from 50 ppm to 5,000 ppm, or from 50 ppm to 2,000 ppm in another embodiment. The amount of hydrogen in the reactor can be from 1 ppm, 50 ppm, or 100 ppm to 400 ppm, 800 ppm, 1,000 ppm, 1,500 ppm, or 2,000 ppm, based on weight. Further, the ratio of hydrogen to total monomer (H₂:monomer) can be 0.00001:1 to 2:1, 0.005:1 to 1.5:1, or 0.0001:1 to 1:1. The one or more reactor pressures in a gas-phase process (either single stage or two or more stages) can vary from 690 kPa, 1,379 kPa, or 1,724 kPa to 2,414 kPa, 2,759 kPa, or 3,448 kPa.

The reactor can be capable of producing greater than 10 kg per hour (kg/hr), greater than 455 kg/hr, greater than 4,540 kg/hr, greater than 11,300 kg/hr, greater than 15,900 kg/hr, greater than 22,700 kg/hr, or greater than 29,000 kg/hr to 45,500 kg/hr of polymer, 70,000 kg/hr, 100,000 kg/hr, or 150,000 kg/hr.

In some embodiments, the polymer product can have a melt index ratio (I_{21.6}/I_{2.16}) ranging from 10 to less than 300, or, in many embodiments, from 20 to 66 The melt index (I_{2.16}) can be measured according to ASTM D-1238-13, condition E (190° C., 2.16 kg), and also referred to as “I₂ (190° C./2.16 kg)”. The melt index (I_{21.6}) can be measured according to ASTM D-1238-13, condition F (190° C., 21.6 kg), and also referred to as “I_{21.6} (190° C./21.6 kg)”.

In some embodiments, the polymer product can have a density ranging from 0.89 g/cm³, 0.90 g/cm³, or 0.91 g/cm³ to 0.95 g/cm³, 0.96 g/cm³, or 0.97 g/cm³ Density can be determined in accordance with ASTM D-792-20. In some embodiments, the polymer product can have a bulk density of from 0.25 g/cm³ to 0.5 g/cm³. For example, the bulk density of the polymer can be from 0.30 g/cm³, 0.32 g/cm³, or 0.33 g/cm³ to 0.40 g/cm³, 0.44 g/cm³, or 0.48 g/cm³ The bulk density can be measured in accordance with ASTM D-1895-17 method B.

In some embodiments, the polymerization process can include contacting one or more olefin monomers with a modified catalyst slurry that can include mineral oil and supported catalyst. The one or more olefin monomers can be ethylene and/or propylene and the polymerization process can include heating the one or more olefin monomers and the catalyst system to 70° C. or more to form ethylene polymers, propylene polymers, or ethylene-propylene copolymers.

In at least one embodiment, the catalysts and processes disclosed herein can be capable of producing ethylene polymers having a weight average molecular weight (Mw) from 40,000 g/mol, 70,000 g/mol, 90,000 g/mol, or 100,000 g/mol to 200,000 g/mol, 300,000 g/mol, 600,000 g/mol, 1,000,000 g/mol, or 1,500,000 g/mol. The Mw can be determined using Gel Permeation Chromatography (GPC). For the GPC data, the differential refractive index (DRI) method is preferred for Mn, while light scattering (LS) is preferred for Mw and Mz. The GPC can be performed on a Waters 150C GPC instrument with DRI detectors. GPC Columns can be calibrated by running a series of narrow polystyrene standards. Molecular weights of polymers other than polystyrenes are conventionally calculated by using Mark Houwink coefficients for the polymer in question.

The ethylene polymers may have a melt index (MI) of 0.2 g/10 min or greater, such as 0.4 g/10 min or greater, 0.6 g/10 min or greater, 0.7 g/10 min or greater, 0.8 g/10 min or greater, 0.9 g/10 min or greater, 1.0 g/10 min or greater, 1.1 g/10 min or greater, or 1.2 g/10 min or greater. In some embodiments, upper limit of MI of the ethylene polymers may be any one of 2.5, 3.0, 3.5, 4.0, 4.5, 5.0, or 5.5 g/10 min. In some or other embodiments, the ethylene polymers may have a melt index up to about 25 g/10 min, or up to about 50 g/10 min, or up to about 100 g/10 min.

“Catalyst productivity” is a measure of how many grams of polymer (P) are produced using a polymerization catalyst comprising W g of catalyst (cat), over a period of time of T hours; and can be expressed by the following formula. P/(T×W) and expressed in units of gPgcat⁻¹hr⁻¹. In at least one embodiment, the productivity of the catalysts disclosed herein can be at least 50 gPgcat⁻¹hr⁻¹ or more, such as 500 gPgcat⁻¹hr⁻¹ or more, such as 800 gPgcar⁻¹hr⁻¹ or more, such as 5,000 gPgcat⁻¹hr⁻¹ or more, such as 6,000 gPgcat⁻¹hr⁻¹ or more.

While gas-phase polymerization processes are described above, it should be understood that other polymerization processes, which are well-known in the art, can also be used to produce the polymer product. In some embodiments, any suspension, homogeneous, bulk, solution, slurry, and/or other gas phase polymerization process known in the art can be used. Such processes can be run in a batch, semi-batch, or continuous mode. A homogeneous polymerization process is defined to be a process where at least about 90 wt % of the product is soluble in the reaction medium. A bulk process is defined to be a process where monomer concentration in all feeds to the reactor is 70 volume % or more. Alternately, no solvent or diluent is present or added in the reaction medium, (except for the small amounts used as the carrier for the catalyst or other additives, or amounts typically found with the monomer; e.g., propane in propylene).

In some embodiments, the polymerization process can be a slurry polymerization process, preferably a continuous slurry loop polymerization reaction process. A single slurry loop reactor can be used, or multiple reactors in parallel or series (although, to achieve a unimodal molecular weight distribution it can be preferable that either a single reactor is used, or that the same catalyst, feed, and reaction conditions are used in multiple reactors, e.g., in parallel, such that the polymer product is considered made in a single reactive step). As used herein, the term “slurry polymerization process” means a polymerization process in which a supported catalyst is used and monomers are polymerized on the supported catalyst particles within a liquid medium (comprising, e.g., inert diluent and unreacted polymerizable monomers), such that a two-phase composition including polymer solids and the liquid circulate within the polymerization reactor. Typically, a slurried tank or slurry loop reactor can be used; in particular embodiments herein, a slurry loop reactor is preferred. In such processes the reaction diluent, dissolved monomer(s), and catalyst can be circulated in a loop reactor in which the pressure of the polymerization reaction is relatively high. The produced solid polymer is also circulated in the reactor. A slurry of polymer and the liquid medium may be collected in one or more settling legs of the slurry loop reactor from which the slurry is periodically discharged to a flash chamber where the mixture can be flashed to a comparatively low pressure; as an alternative to settling legs, in other examples, a single point discharge process can be used to move the slurry to the flash chamber. The flashing results in substantially complete removal of the liquid medium from the polymer, and the vaporized polymerization diluent (e.g., isobutane) can then be recompressed in order to condense the recovered diluent to a liquid form suitable for recycling as liquid diluent to the reactor.

Slurry polymerization processes can include those described in U.S. Pat. No. 6,204,344. Other non-limiting examples of slurry processes include continuous loop or stirred tank processes. Also, other examples of slurry processes include those described in U.S. Pat. No. 4,613,484. In still other embodiments, the polymerization process can be a multistage polymerization process where one reactor is operating in slurry phase that feeds into a reactor operating in a gas phase as described in U.S. Pat. No. 5,684,097.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

### Additional Embodiments

The present disclosure is further directed to the following non-limiting embodiments.

Embodiment 1. A method comprising:
providing a catalyst slurry comprising a supported catalyst, the supported catalyst comprising a support material, at least one catalyst compound, and at least one activator;
introducing the catalyst slurry to a line in fluid communication with a mixing unit;
introducing at least a first portion of a catalyst solution to the line upstream from the mixing unit, the catalyst solution comprising a first catalyst compound already contained upon the supported catalyst or a second catalyst compound different from the first catalyst compound and not already contained upon the supported catalyst;
contacting the catalyst slurry with the catalyst solution in the line and in the mixing unit to obtain a modified catalyst slurry from the mixing unit, the modified catalyst slurry comprising a modified supported catalyst incorporating at least a portion of the first catalyst compound or the second catalyst compound from the catalyst solution;
feeding the modified catalyst slurry to a fluidized bed gas-phase reactor; and
polymerizing an α-olefin in the fluidized bed gas-phase reactor under polymerization conditions to obtain a polyolefin.

Embodiment 2. The method of embodiment 1, further comprising:
introducing a second portion of the catalyst solution directly to the mixing unit.

Embodiment 3 The method of embodiment 1 or embodiment 2, wherein the catalyst solution and the catalyst slurry have a contact time of at least about 5 minutes within the line.

Embodiment 4. The method of embodiment 3, wherein the catalyst solution and the catalyst slurry have a total contact time within the line and in the mixing unit of at least about 6 minutes.

Embodiment 5. The method of any one of embodiments 1-4, wherein the catalyst solution comprises the second catalyst compound.

Embodiment 6. The method of any one of embodiments 1-5, wherein the first catalyst compound comprises a first metallocene and the second catalyst compound comprises a second metallocene different from the first metallocene.

Embodiment 7. The method of any one of embodiments 1-6, wherein the at least one catalyst compound upon the supported catalyst comprises at least the first catalyst compound and the catalyst solution comprises the second catalyst compound.

Embodiment 8. The method of embodiment 7, wherein the at least one catalyst compound upon the supported catalyst further comprises the second catalyst compound.

Embodiment 9. The method of any one of embodiments 1-8, wherein the first catalyst compound comprises rac/meso dimethylsilylbis[((trimethylsilyl)methyl)cyclopentadienyl]hafnium dimethyl.

Embodiment 10. The method of any one of embodiments 1-9, wherein the second catalyst compound comprises rac/meso bis(1-methylindenyl) zirconium dimethyl.

Embodiment 11. The method of any one of embodiments 1-10, wherein the mixing unit is a mechanically agitated mixing pot.

Embodiment 12 The method of any one of embodiments 1-10, wherein the mixing unit is a static mixer or mixing block.

Embodiment 13. The method of any one of embodiments 1-12, wherein the at least one activator comprises an alumoxane.

Embodiment 14. The method of any one of embodiments 1-13, wherein the modified catalyst slurry is fed to fluidized bed the gas-phase reactor at a flow rate of about 0.1 kg/hr·cm³ to about 0.5 kg/hr·cm³, based on a volume of the fluidized bed gas-phase reactor.

Embodiment 15. The method of any one of embodiments 1-14, wherein the α-olefin comprises ethylene and, optionally, one or more α-olefin comonomers.

Embodiment 16 The method of any one of embodiments 1-15, wherein the catalyst slurry further comprises a mineral oil, a wax, an induced condensing agent, or any combination thereof.

Embodiment 17. The method of embodiment 16, wherein the mineral oil is present at a concentration of about 8 wt % to about 68 wt %, the wax is present at a concentration of about 2 wt % to about 15 wt %, and the induced condensing agent is present at a concentration of about 30 wt % to about 90 wt %, each based on total mass of the catalyst slurry.

Embodiment 18. The method of embodiment 16 or embodiment 17, wherein the induced condensing agent is present and comprises propane, isobutane, isopentane, isohexane, or any combination thereof.

Embodiment 19. The method of any one of embodiments 1-18, wherein the catalyst slurry comprises about 1 wt % to about 40 wt % solids, based on a total mass of the catalyst slurry.

Embodiment 20. The method of any one of embodiments 1-19, wherein polymer sheets are formed at a rate of about 0.3% or less, based on a total polyolefin production rate.

To facilitate a better understanding of the embodiments of the present disclosure, the following examples of preferred or representative embodiments are given. In no way should the following examples be read to limit, or to define, the scope of the invention.

### Examples

1-Hexene/ethylene copolymerization reactions were conducted using a conventional multi-catalyst reaction system with static mixing of a catalyst slurry and a catalyst solution to produce a modified catalyst slurry (e.g., a system similar to system 100 in FIG. 1, except replacing the mechanically agitated mixing pot with a static mixer) and a revised system utilizing a jumpover line to produce a modified catalyst slurry with further inline mixing upstream from the static mixer (e.g., a system similar to system 200 in FIG. 2). The supported catalyst in the catalyst slurry comprised a rac/meso dimethylsilybis[(trimethylsilyl)methyl)cyclopentadienyl]hafnium dimethyl, and the catalyst solution comprised a solvent solution of a rac/meso bis(1-methylindenyl) zirconium dimethyl. By utilizing the jumpover line, an additional 6.8 minutes of contact time between the catalyst slurry and the catalyst solution was realized prior to the modified catalyst slurry entering the gas-phase fluidized bed polymerization reactor. Polymerization reactions were run in the same reactor, first under conventional conditions without a jumpover line (Run 1), second with revised conditions utilizing a jumpover line (Run 2), and finally (third) returning the reactor to conventional conditions after an extended run time to flush modified catalyst slurry from the reactor (Run 3). Further polymerization details and characterization the ethylene polymers resulting from the polymerization reactions are given in Table 1.

TABLE 1

| | Conventional | Jumpover Line | Conventional |
|---|---|---|---|
| | (Run 1) | (Run 2) | (Run 3) |
| Polymer density [g/cm³] | 0.9210 | 0.9235 | 0.9236 |
| (ASTEM D1505) | | | |
| Polymer melt flow ratio (I₂₁:I₂) | 29.12 | 31.27 | 30.97 |
| Polymer melt index [dg/min] | 0.71 | 0.80 | 0.80 |
| (ASTM D-1238, 2.16 kg, 190° C.) | | | |
| Reactor bed weight [tonne] | 68.2 | 70.0 | 69.3 |
| Upper reactor bed density [kg/m³] | 312 | 321 | 318 |
| Lower reactor bed density [kg/m³] | 310 | 318 | 317 |
| Reaction residence time [h] | 2.42 | 2.60 | 2.58 |
| Catalyst solution/catalyst slurry ratio [kg/kg] | 0.0567 | 0.0560 | 0.0561 |
| Hydrogen gas/ethylene ratio [ppm H₂/mol % C₂] | 4.07 | 4.08 | 4.15 |
| H₂/ethylene flow ratio [kg H₂/tonne C₂₋] | 0.038 | 0.049 | 0.037 |
| Hexene/ethylene flow ratio [kg C₆₌/kg C₂₌] | 0.093 | 0.093 | 0.093 |
| Reactor Temperature [° C.] | 82.0 | 82.0 | 82.0 |

In Table 1, the polymer melt flow ratio is the ratio of the high-load polymer melt index (ASTM D-1238, 21.6 kg, 190° C., I₂₁) to polymer melt index (ASTM D-1238, 2.16 kg, 190° C., I₂).

Comparing Run 1 against Run 2, the polyethylene copolymer produced by increasing the contact time between the catalyst slurry and the catalyst solution had a higher melt flow ratio. Moreover, the fluidized bed had a higher bed density and bed weight in Run 2 Upon returning to conventional conditions in Run 3, the performance dropped, but not quite to the performance level in Run 1, mostly likely due to residual modified supported catalyst from Run 2 remaining in the reactor.

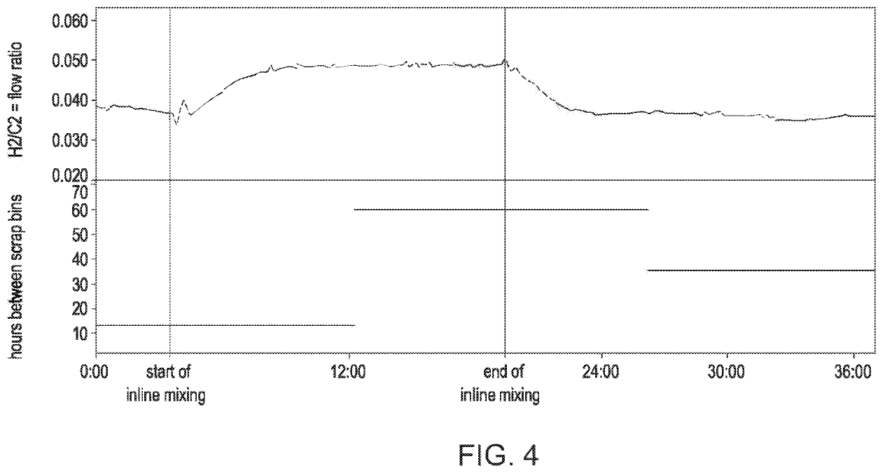

The foregoing improvements with increased contact time between the catalyst slurry and the catalyst solution are further illustrated graphically in FIG. 4. FIG. 4 is a graph of H₂/ethylene flow ratio and extent of polymer sheeting under conventional catalyst slurry/catalyst solution contacting conditions and extended catalyst slurry/catalyst solution contacting conditions according to the disclosure herein. Baseline conditions were initially established in FIG. 4 with contact between the catalyst solution and the catalyst slurry taking place in an inline mixer. Subsequently, at least a portion of the catalyst solution was diverted and mixed with the catalyst slurry inline for 5-6 minutes. Afterward, the conditions were returned to the baseline conditions.

As shown in Table 1 and FIG. 4, the polyethylene copolymer produced by increasing the contact time between the catalyst slurry and the catalyst solution (Run 2 versus Run 1) had a higher H₂/ethylene flow ratio at a similar H₂/ethylene gas ratio, as well as the higher polymer melt flow ratio. Under the tested conditions, the increase in the H₂/ethylene flow ratio at a steady H₂/ethylene gas ratio and the increase in melt flow ratio are consistent with more of the catalyst in the catalyst solution catalyst becoming activated on the catalyst support with increased contact time. The H₂/ethylene flow ratio dropped once the extended contact time was reverted to conventional conditions.

As also shown in FIG. 4, the increased contact time between the catalyst solution and the catalyst slurry resulted in a decrease in the sheeting rate, as indicated by more time between removal of sheeted polymer from scrap bins. Each time the scrap bin was emptied, the fill level was noted so as to estimate the number of hours that would have been required for the bin to become completely full before emptying. The bin emptied during Run 2 and the first bin emptied after Run 2 (FIG. 4) showed that the increased contact time yielded a dramatic improvement from approximately 13 hours to 60 hours between bin dumps. The increase in bed density and bed weight also is consistent with an expected reduction in sheeting. Upon returning to conventional conditions, the sheeting performance dropped.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b.” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method comprising:
providing a catalyst slurry comprising a supported catalyst, the supported catalyst comprising a support material, at least one catalyst compound, and at least one activator;
introducing the catalyst slurry to a line in fluid communication with a mixing unit;
introducing at least a first portion of a catalyst solution to the line upstream from the mixing unit, the catalyst solution comprising a first catalyst compound already contained upon the supported catalyst or a second catalyst compound different from the first catalyst compound and not already contained upon the supported catalyst;
contacting the catalyst slurry with the catalyst solution in the line and in the mixing unit to obtain a modified catalyst slurry from the mixing unit, the modified catalyst slurry comprising a modified supported catalyst incorporating at least a portion of the first catalyst compound or the second catalyst compound from the catalyst solution;
feeding the modified catalyst slurry to a fluidized bed gas-phase reactor; and
polymerizing an α-olefin in the fluidized bed gas-phase reactor under polymerization conditions to obtain a polyolefin.

2. The method of claim 1, further comprising:
introducing a second portion of the catalyst solution directly to the mixing unit.

3. The method of claim 1, wherein the catalyst solution and the catalyst slurry have a contact time of at least about 5 minutes within the line.

4. The method of claim 3, wherein the catalyst solution and the catalyst slurry have a total contact time within the line and in the mixing unit of at least about 6 minutes.

5. The method of claim 1, wherein the catalyst solution comprises the second catalyst compound.

6. The method of claim 1, wherein the first catalyst compound comprises a first metallocene and the second catalyst compound comprises a second metallocene different from the first metallocene.

7. The method of claim 1, wherein the at least one catalyst compound upon the supported catalyst comprises at least the first catalyst compound and the catalyst solution comprises the second catalyst compound.

8. The method of claim 7, wherein the at least one catalyst compound upon the supported catalyst further comprises the second catalyst compound.

9. The method of claim 1, wherein the first catalyst compound comprises rac/meso dimethylsilylbis[((trimethylsilyl)methyl)cyclopentadienyl]hafnium dimethyl.

10. The method of claim 9, wherein the second catalyst compound comprises rac/meso bis(1-methylindenyl) zirconium dimethyl.

11. The method of claim 1, wherein the mixing unit is a mechanically agitated mixing pot.

12. The method of claim 1, wherein the mixing unit is a static mixer or mixing block.

13. The method of claim 1, wherein the at least one activator comprises an alumoxane.

14. The method of claim 1, wherein the modified catalyst slurry is fed to fluidized bed the gas-phase reactor at a flow rate of about 0.1 kg/hr·cm³ to about 0.5 kg/hr·cm³, based on a volume of the fluidized bed gas-phase reactor.

15. The method of claim 1, wherein the α-olefin comprises ethylene and, optionally, one or more α-olefin comonomers.

16. The method of claim 1, wherein the catalyst slurry further comprises a mineral oil, a wax, an induced condensing agent, or any combination thereof.

17. The method of claim 16, wherein the mineral oil is present at a concentration of about 8 wt % to about 68 wt %, the wax is present at a concentration of about 2 wt % to about 15 wt %, and the induced condensing agent is present at a concentration of about 30 wt % to about 90 wt %, each based on total mass of the catalyst slurry.

18. The method of claim 16, wherein the induced condensing agent is present and comprises propane, isobutane, isopentane, isohexane, or any combination thereof.

19. The method of claim 1, wherein the catalyst slurry comprises about 1 wt % to about 40 wt % solids, based on a total mass of the catalyst slurry.

20. The method of claim 1, wherein polymer sheets are formed at a rate of about 0.3% or less, based on a total polyolefin production rate.
